(19) United States
(12) Patent Application Publication
(10) Pub. No.: US 2023/0320453 A1
(43) Pub. Date: Oct. 12, 2023

(54) IMPROVED FOOTWEAR

(71) Applicant: 9772782 CANADA INC., Montreal, QC - QUEBEC (CA)

(72) Inventor: Gerard Dervishian, Montreal (CA)

(21) Appl. No.: 18/042,870

(22) PCT Filed: Aug. 25, 2021
(86) PCT No.: PCT/CA2021/051176

§ 371 Date: Feb. 24, 2023

(30) Foreign Application Priority Data
Aug. 25, 2020 (CA) 3091057

(51) Int. Cl. A43B 1/025; A43B 1/00; A43B 13/12; A43B 23/07

(52) U.S. Cl. CPC A43B 1/025; A43B 1/0063; A43B 13/12; A43B 23/07

(57) ABSTRACT

A footwear is for wearing on a foot of a user. The footwear includes at least one component (ex. only one single component, or a plurality/combination of different components, etc.) selected from an upper, a lining, a midsole, an outsole, an insole and at least one lace. The at least one component is made of a material based on a lignocellulose substance and having been converted into a corresponding fabric (ex. a bamboo lyocell fabric, etc.), without, or at the very least, with reduced chemicals or synthetics like rayon (polyester). The resulting footwear has various advantages in terms of “sustainability” and “functionality”, as well as other advantages, when compared to conventional footwear.

### FIELD OF THE INVENTION

The present invention relates to the field of footwear and the like. More particularly, the present invention relates to a new and improved footwear (hereinafter referred to also simply as “shoe”, to be commercialized by the Applicant as the LongRun™ shoe), and also relates to a kit with corresponding components for assembling the same, and to corresponding methods of manufacturing, assembling and/or use associated thereto.

### BACKGROUND

Footwear, such as sneakers, running shoes and the like, are well known in the part. Also well known in the art are the various possible materials and manufacturing methods that are typically employed for such footwear, and the associated drawbacks, namely, the fact that some materials used are not environmentally friendly, nor easily biodegradable, causing corresponding major and impactful consequences upstream, during and downstream of the manufacturing process of the footwear, as well as after the useful lifecycle of the footwear when it is disposed, etc.

Improvements have been made over the years in regards to possible choices of materials to be used for the manufacturing of footwear. For example, currently in the market, shoe uppers and lining materials are sometimes made of Tencel™, a lyocell made with eucalyptus trees, and thus, have a lesser impact on the environment compared to the use of synthetic materials.

Also known to the Applicant is U.S. Pat. No. 8,926,712 B2 granted to JIANG et al., on Jan. 6, 2015, and relating to a “solvent spun bamboo fiber with high wet modulus and producing method thereof”. This document describes a solvent spun bamboo fiber with a high wet modulus and a producing method thereof are disclosed. The producing method includes: activating by adding a bamboo pulp into de-ionized water, adjusting the pH value, adding cellulase and adjusting the pH value by adding alkali; squeezing by vacuum dehydration; pre-dissolving by adding an aqueous solution containing 50-88% by mass of N-methylmorpholine-N-oxide; then dissolving by putting the above pre-dissolved mixture into a dissolver, heating, vacuumizing, dehydrating, dissolving, homogenizing and defoaming; spinning by spraying through a spinneret and forming a bamboo fiber by dry-wet spinning; water washing; bleaching; oiling; and drying. The present method is simple to operate, free of industrial pollution, low energy consuming, and highly safe. The bamboo fiber produced by the present method not only keeps the natural physical and chemical properties of bamboo fiber, but also has a high wet modulus without harmful chemical residues.

Despite these types of improvements over the years, there is always a need to continue innovating and finding better and/or different ways of manufacturing footwear and associated materials, and to do so, in a quicker, simpler, more precise, more efficient, more economical, more reliable, more adjustable, more versatile, more adaptable, more durable, more environmentally conscientious, more functional, more sustainable, more desirable, and/or improved manner, than what is possible with the actual way of doing things.

Therefore, it would be particularly useful to be able to provide such a new footwear which would be able to overcome or at the very least minimize some of known drawbacks associated with the conventional footwear and/or the conventional ways of manufacturing the same.

### SUMMARY OF THE INVENTION

An object of the present invention is to provide a footwear which, by virtue of its design and components, would be an improvement over other related conventional footwears and/or associated ways of manufacturing the same being known in the prior art.

In accordance with the present invention, the above object is achieved, as will be easily understood from the present description, with a footwear (also referred to herein simply as “shoe”, “system” and/or “LongRun™”) such as the one briefly described herein and such as the one exemplified in the accompanying drawing(s).

More particularly, according to one aspect of the present invention, an object is to provide footwear for wearing on a foot of a user, the footwear comprising at least one component selected from the group consisting of an upper, a lining, a midsole, an outsole, an insole and at least one lace, wherein said at least one component is made of a material based on a lignocellulose substance (ex. bamboo lyocell fabric, etc.).

According to yet another aspect of the invention, there is also provided a method of manufacturing components of the above-mentioned footwear.

According to yet another aspect of the invention, there is also provided a method of assembling components of the above-mentioned footwear.

According to yet another aspect of the invention, there is also provided a method of using the above-mentioned footwear and/or component(s) thereof.

According to yet another aspect of the invention, there is also provided a kit with components for assembling the above-mentioned footwear.

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present invention, there is also provided a method of doing business with the above-mentioned footwear, component(s) thereof, kit, set and/or method(s).

The objects, advantages, and other features of the present invention will become more apparent upon reading of the following non-restrictive description of preferred embodiments thereof, given for the purpose of exemplification only, with reference to the accompanying drawing(s).

### BRIEF DESCRIPTION OF THE DRAWINGS

FIG. 1 is a side view of a footwear according to a possible embodiment of the present invention.

FIG. 2 is a bottom view of a sole to be used with the footwear shown in FIG. 1 according to a possible embodiment of the present invention.

FIG. 3 is a top view of a footbed to be used with the footwear shown in FIG. 1 according to a possible embodiment of the present invention.

FIG. 4 is a side view of a footwear according to a possible embodiment of the present invention.

FIG. 5 is a bottom view of a sole to be used with the footwear shown in FIG. 4 according to a possible embodiment of the present invention.

FIG. 6 is a top view of a footbed to be used with the footwear shown in FIG. 4 according to a possible embodiment of the present invention.

FIG. 7 is a side view of a footwear according to a possible embodiment of the present invention.

FIG. 8 is a bottom view of a sole to be used with the footwear shown in FIG. 7 according to a possible embodiment of the present invention.

FIG. 9 is a top view of a footbed to be used with the footwear shown in FIG. 7 according to a possible embodiment of the present invention.

FIG. 10 is a side view of a footwear according to a possible embodiment of the present invention.

FIG. 11 is a bottom view of a sole to be used with the footwear shown in FIG. 10 according to a possible embodiment of the present invention.

FIG. 12 is a top view of a footbed to be used with the footwear shown in FIG. 10 according to a possible embodiment of the present invention.

FIG. 13 is a side view of a footwear according to a possible embodiment of the present invention.

FIG. 14 is a bottom view of a sole to be used with the footwear shown in FIG. 13 according to a possible embodiment of the present invention.

FIG. 15 is a top view of a footbed to be used with the footwear shown in FIG. 13 according to a possible embodiment of the present invention.

FIG. 16 is a rear view of a sample prototype of a footwear according to a possible embodiment of the present invention, the sample prototype being shown with upper and lining materials made of bamboo lyocell fabric, and the sample prototype being also shown with a possible logo of the LongRun™ shoe being provided about a rear portion of the midsole.

FIG. 17 is a 4-page document representing different views of various aspects, components and features of bamboo lyocell and/or different configurations thereof (ex. fabric, material, etc.) according to possible preferred embodiments of the present invention.

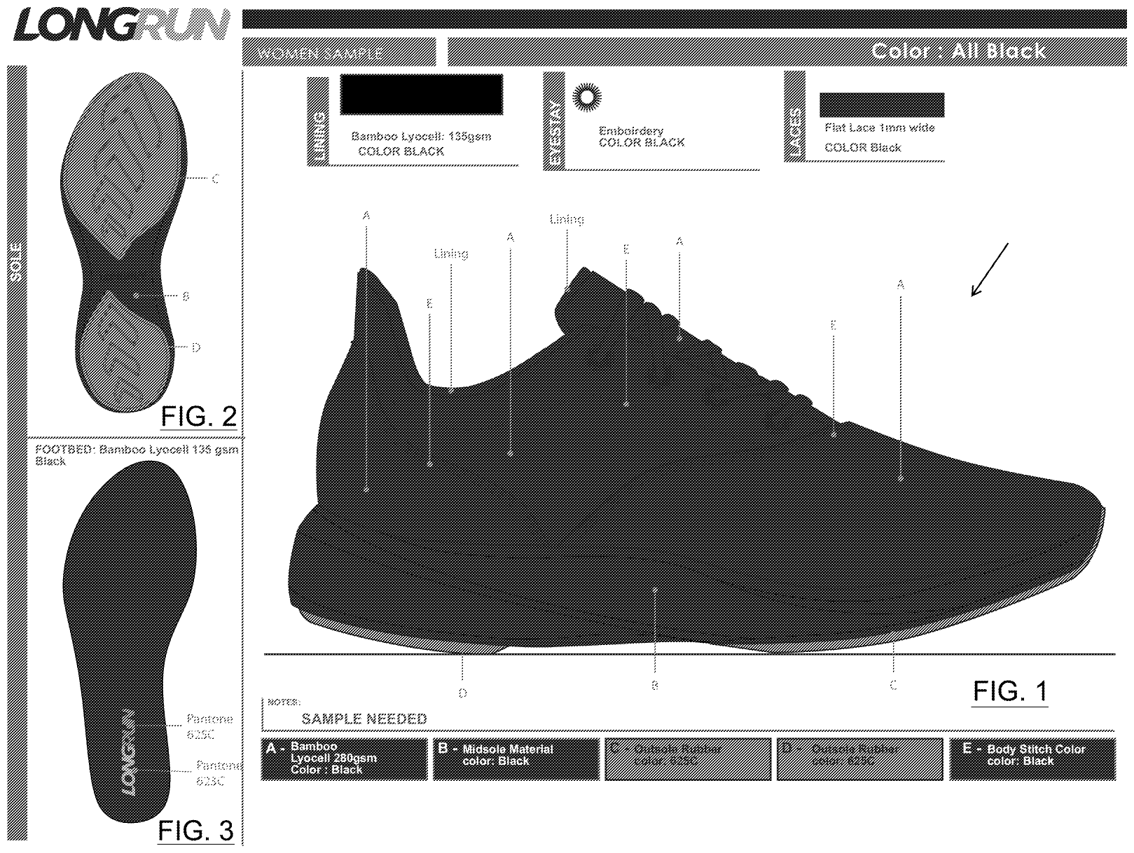

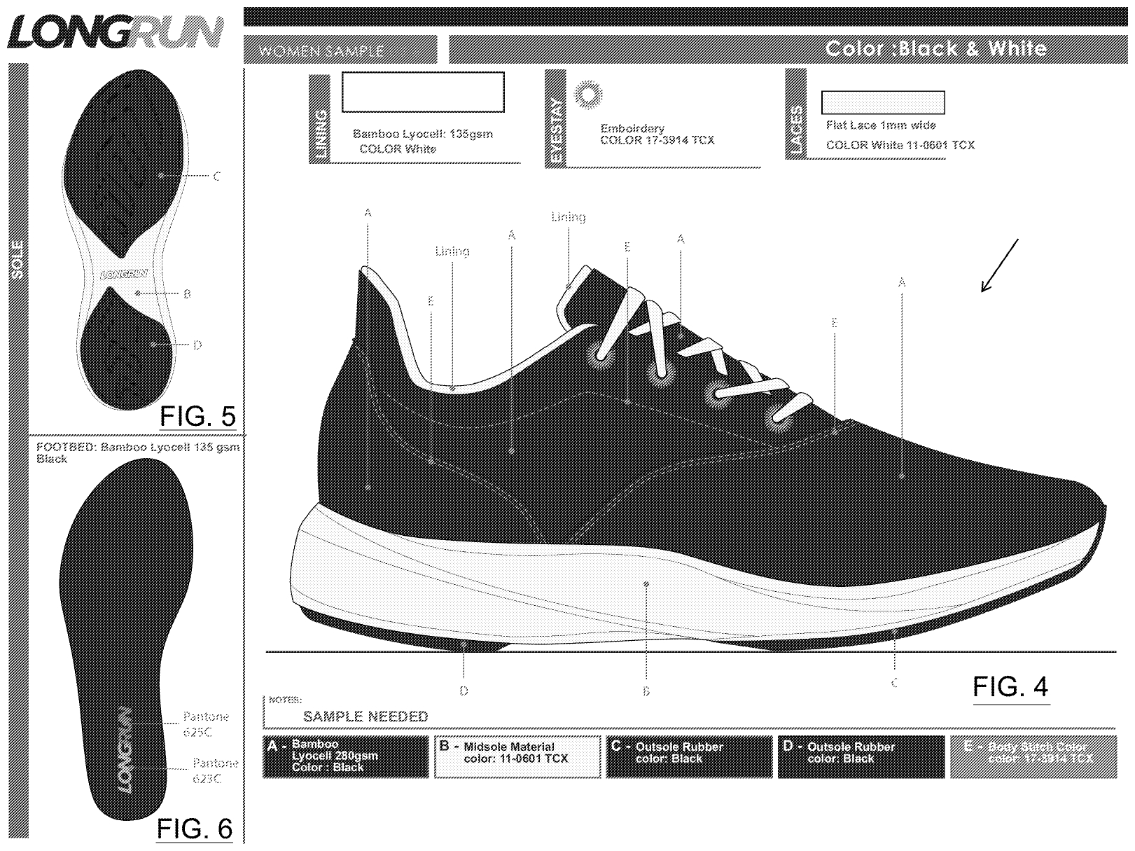

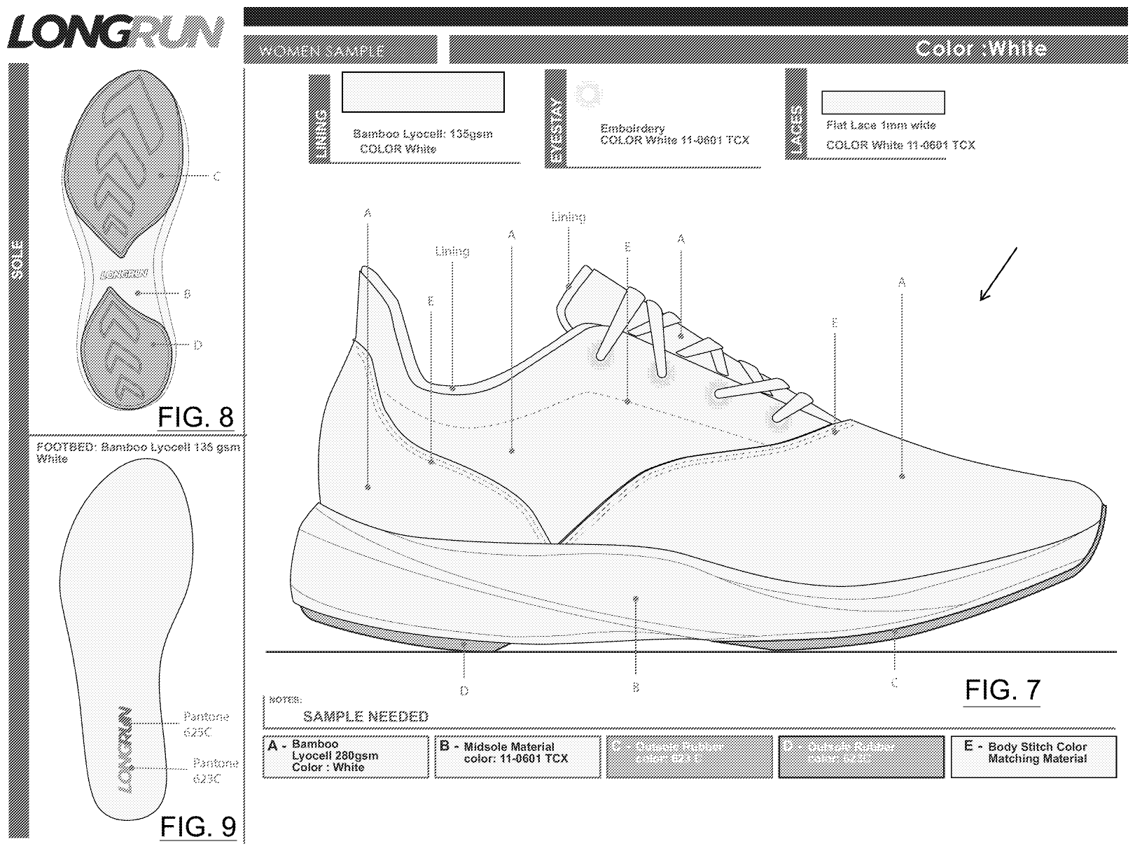

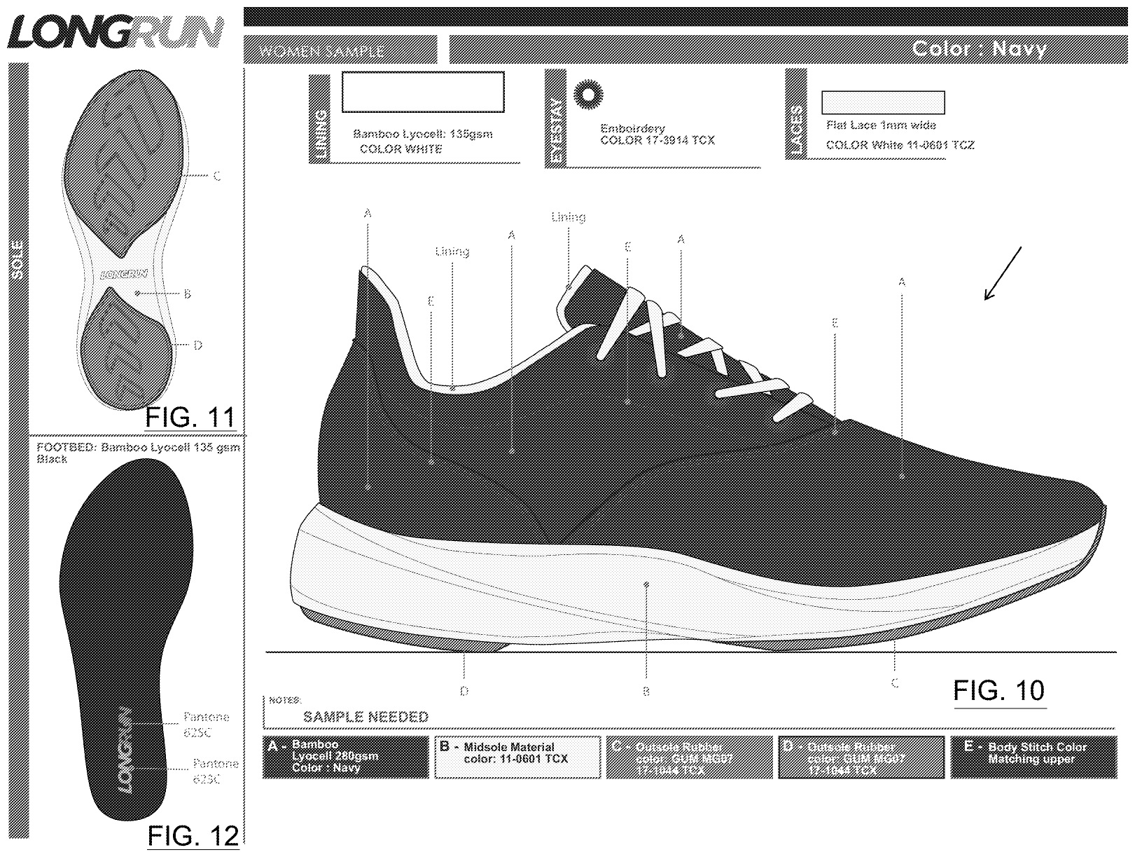

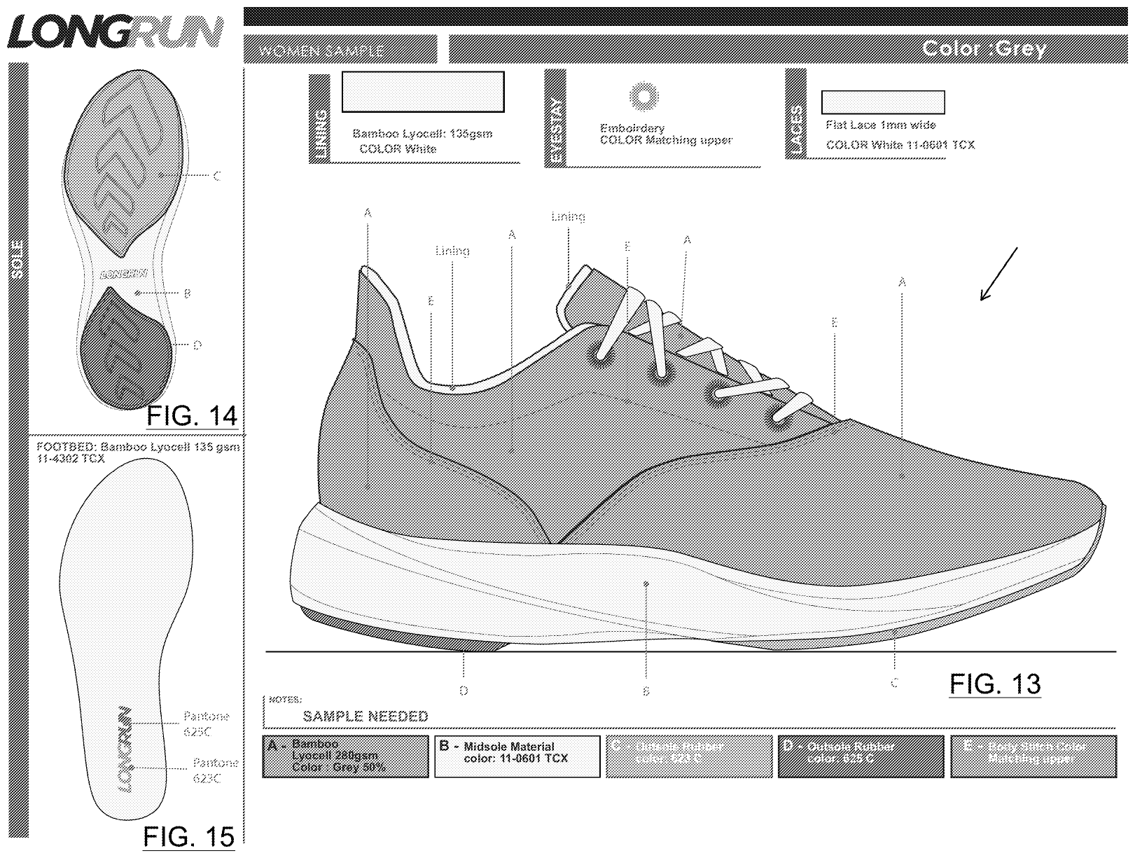

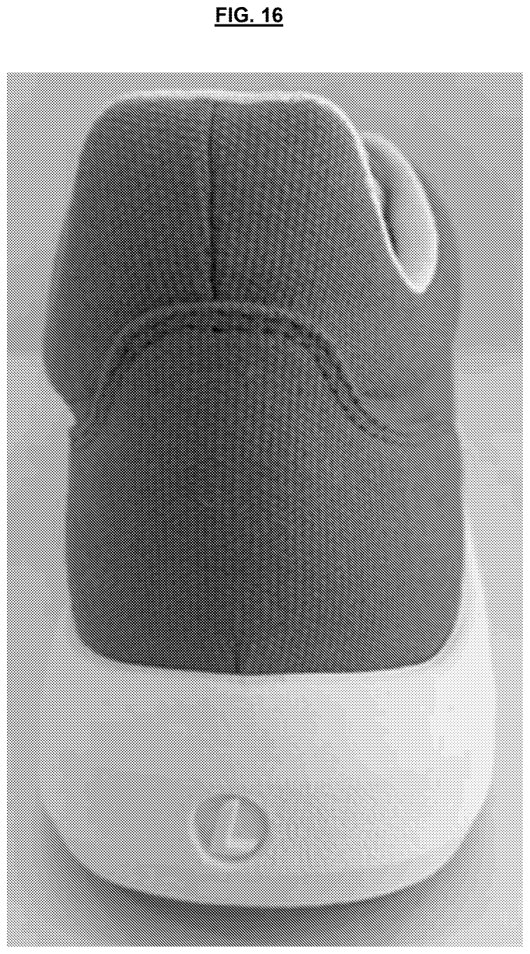

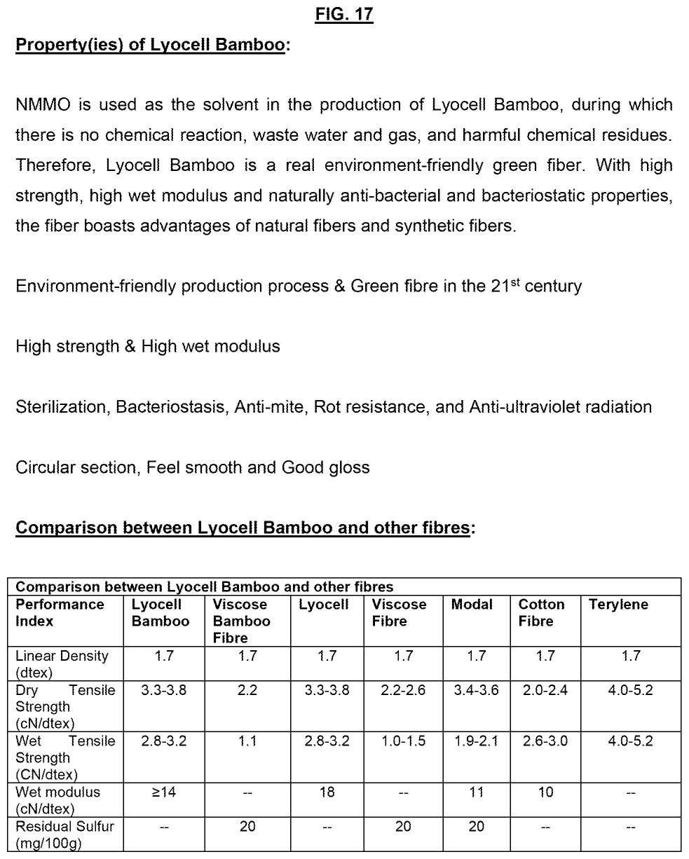

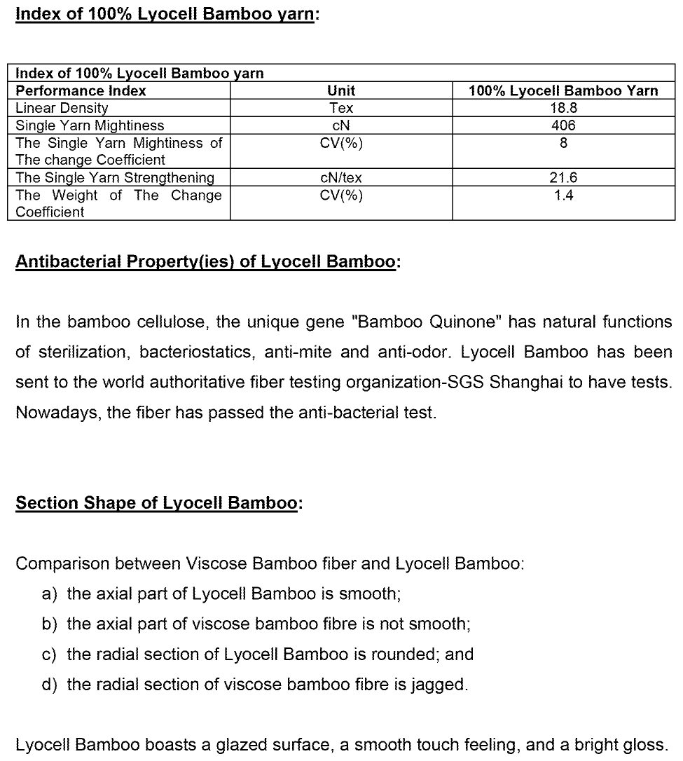

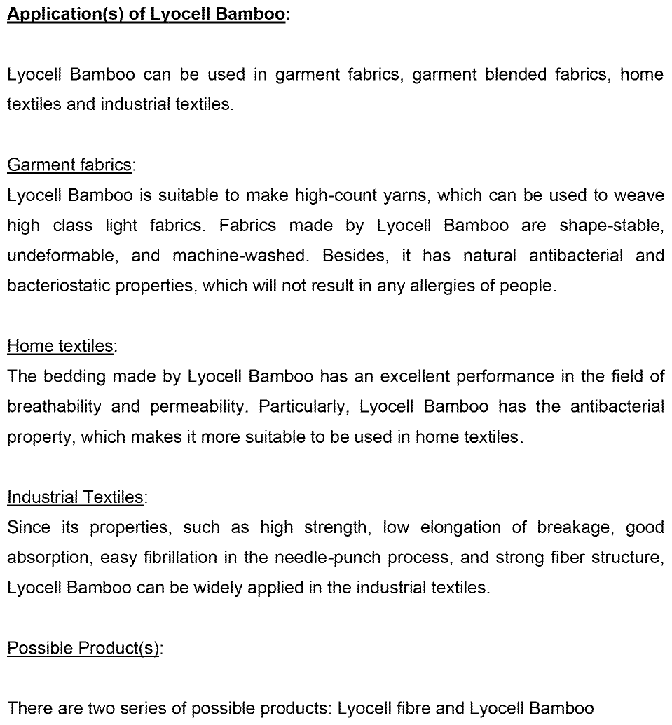

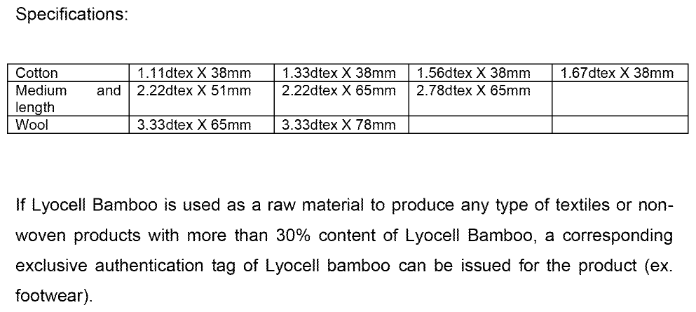

### DETAILED DESCRIPTION OF PREFERRED EMBODIMENTS OF THE INVENTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for use with footwear (ex. shoes, etc.), for example, it may be used with other objects and/or in other types of applications, as apparent to a person skilled in the art. For this reason, expressions such as “footwear”, “shoe”, etc., used herein should not be taken so as to limit the scope of the present invention and include all other kinds of objects and/or applications with which the present invention could be used and may be useful, such as apparel, clothes, garments, socks, hats, bags, accessories and/or the like, for example, as can be easily understood by a person skilled in the art.

Moreover, in the context of the present invention, the expressions “footwear”, “shoe”, “system”, “assembly”, “device”, “apparatus”, “product”, “unit”, “equipment”, “method” and “kit”, as well as any other equivalent expression(s) and/or compound word(s) thereof known in the art will be used interchangeably, as apparent to a person skilled in the art. This applies also for any other mutually equivalent expressions, such as, for example: a) “lignocellulose”, “plant”, “biomass”, “evergreen”, “perennial”, “grass”, “stem”, “wood”, “bamboo”, “cellulose”, “hemicellulose”, “lignin”, etc.; b) “lining”, “material”, “fabric”, “canvas”, “portion”, “part”, “pod”, “component”, “sub-component”, etc.; c) “transforming”, “converting”, “processing”, “treating”, “modifying”, “altering”, “changing”, etc.; as well as for any other mutually equivalent expressions, pertaining to the aforementioned expressions and/or to any other structural and/or functional aspects of the present invention, as also apparent to a person skilled in the art. Also, in the context of the present description, expressions such as “can”, “may”, “might”, “will”, “could”, “should”, “would”, etc., may also be used interchangeably, whenever appropriate, as also apparent to a person skilled in the art.

Furthermore, in the context of the present description, it will be considered that all elongated objects will have an implicit “longitudinal axis” or “centerline”, such as the longitudinal axis of a shoe or a sole, for example, or the centerline of a coiled spring, for example, and that expressions such as “connected” and “connectable”, or “mounted” and “mountable”, may be interchangeable, in that the present invention also relates to a kit with corresponding components for assembling a resulting fully-assembled and fully-operational footwear, as also apparent to a person skilled in the art.

Moreover, components of the present system(s) and/or steps of the method(s) described herein could be modified, simplified, altered, omitted and/or interchanged, without departing from the scope of the present invention, depending on the particular applications which the present invention is intended for, and the desired end results, as briefly exemplified herein and as also apparent to a person skilled in the art.

In addition, although the preferred embodiments of the present invention as illustrated in the accompanying drawings comprise various components, and although the preferred embodiments of the present footwear and corresponding portion(s)/part(s)/component(s) as shown consist of certain geometrical configurations, as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation thereinbetween, as well as other suitable geometrical configurations may be used for the present footwear and corresponding portion(s)/part(s)/component(s) according to the present invention, as will be briefly explained herein and as can be easily inferred herefrom by a person skilled in the art, without departing from the scope of the present invention.

### LIST OF NUMERICAL REFERENCES FOR SOME OF THE CORRESPONDING POSSIBLE COMPONENTS ILLUSTRATED IN THE ACCOMPANYING DRAWING(S)

1. footwear

3. upper (ex. component A)

5. lining (ex. component A)

7. midsole (ex. component B)

9. outsole (ex. component(s) C and/or D)

11. insole (ex. footbed)

13. lace (ex. pair of laces)

15. eyestay

Broadly described, and as better exemplified in the accompanying drawings, the present invention relates to a footwear comprising at least one component selected from the group consisting of an upper, a lining, a midsole, an outsole, an insole and at least one lace, wherein said at least one component is made of a material based on a lignocellulose substance, and having been converted into a corresponding fabric (ex. a bamboo lyocell fabric, etc.), without, or at the very least, with considerably reduced chemicals or synthetics like rayon (polyester), etc. Indeed, and according to a preferred embodiment of the present system, the bamboo lyocell fabric used for the footwear and component(s) thereof is all “natural” and “non-blend” (ex. without polyethylene terephthalate (PET), etc.). Therefore, and as will be explained in greater detail hereinbelow, the resulting footwear according to the present system provides various advantages in terms of “sustainability” and “functionality”, when compared to conventional footwear.

Furthermore, and in order to know more about the properties and advantages of “bamboo”, and other possible related aspects and/or information, reference is made to the following link: https://www.intechopen.com/books/bam boo-current-and-future-prospects/bamboo-its-chemical-modification-and-products, the content of which is incorporated herein by reference. Namely, it is mentioned that:
“Bamboo, a perennial woody grass belonging to Gramineae family and Bambuseae subfamily, is ubiquitous in many parts of the world. This biomass possesses high potential as a substitute for many lignocellulosic and non-lignocellulosic materials in various capacities of applications owing to its chemical composition as well as its physical properties.”
“Bamboo is a perennial woody grass, which belongs to the family Gramineae and subfamily Bambuseae [7]. It is an evergreen, monocotyledonous (i.e. non-woody) plant, which produces primary shoot without any later secondary growth [8].”
“Bamboo is considered an alternative to wood owing to their excellent qualities in physical and mechanical attributes [23]. It attains maturity in 3 years as compared to wood, which takes almost more than 20 years. After maturity, the tensile strength of bamboo is comparable to that of mild steel [15]. It is one of the fastest growing plants [8]. It can grow in areas that are currently non-productive (e.g. on an eroded slope), and its root structure remains intact after harvest, thus, generating new shoots [24]. Bamboo grows in plains, hilly and high altitude mountainous regions, and in most kinds of soils, except alkaline soils, desert and marsh [25].”
“According to their morphology, bamboos are broadly divided into monopodial (or running) bamboos with ‘leptomorph’ rhizome system and sympodial (clumping) bamboos with ‘pachymorph’ rhizome system. These differences in rhizome systems can be because of their adaptations to climate conditions to which the bamboos belong. As a typical forest plant in the tropical and subtropical area, bamboo forest plays significant roles in its biological characteristics and growth habits. Apart from its socio-economical utilisation, bamboo has many environmental benefits [7]. It has some ecological functions on soil erosion control, water conservation, land rehabilitation, carbon sequestration, etc. In China, bamboo forests are recognised as a massive carbon sink in the global cycles of carbon. They have high potentials in carbon fixation, and this is due to the prediction that the carbon stocks in bamboo stands based on previous data for 2050 may get to 1017.64 Tg C [26] or reach 1138.8 Tg C [27].”
“Some studies have revealed bamboo to produce higher biomass yield than other lignocelluloses crops with a growth rate ranging from 30 to 60 cm/day and height of about 36 m in growing season [28]. The aboveground biomass of bamboo in the Philippines was first reported as 146.8 Mg ha⁻¹ year⁻¹ (Suzuki and Jacalne [119]). Nath et al. [29] reported that the total aboveground standing biomass of bamboo in northeast India was 42.98 Mg ha⁻¹ year⁻¹. Hong et al. [30], when comparing the annual biomass yield between bamboo and Miscanthus species, reported that of bamboo to range from 5.9 to 49.5 Mg ha⁻¹ year⁻¹.”
“Cellulose, hemicelluloses and lignin are the three major chemical compositions of bamboo, and they are closely associated in a complex structure [31]. They contribute about 90% of the total bamboo mass. The minor components are pigments, tannins, protein, fat, pectin and ash. Others include resins, waxes and inorganic salts. These constituents play an important role in physiological activity of bamboo, and they are found in cell cavity or special organelles [15]. The chemical composition of bamboo is known to be similar to that of wood, but bamboo has a higher content of minor components compared with wood [32].”

“Li et al. [33] in their studies reported the chemical composition of bamboo fibre as shown in Table 4. Usually, there is variation in the chemical composition of bamboo depending on their age. Notably, cellulose content decreases with increase in age of bamboo. Different authors have investigated different species and bamboo parts. They include bamboo (Kumamoto, Japan) with cellulose content of 47%, hemicelluloses 23% and lignin 28% [9]; bamboo with cellulose 43%, hemicelluloses 15% and lignin 26% [34]; bamboo (Dendrocalamus sp.) with cellulose 47%, hemicelluloses 16% and lignin 18% [35]; bamboo with cellulose 44%, hemicelluloses 30% and lignin 26% [36]; Moso bamboo (Phyllostachys pubescens Mazel), with cellulose 46%, hemicelluloses 23% and lignin 26% [37]; bamboo (Dendrocalamus asper) with cellulose 41%, hemicelluloses 27% and lignin 27% [38]; Moso bamboo (Phyllostachys heterocycla), with cellulose 42-47%, hemicelluloses 22-23% and lignin 23-31% [39]; bamboo, with cellulose 38.4%, hemicelluloses 20.5% and lignin 20.8% [40]; Moso bamboo (Phyllostachys heterocycla), with cellulose 37%, hemicelluloses 22% and lignin 24% [41]; bamboo shoots shell fibre (BSSF), with cellulose 23%, hemicelluloses 14% and lignin 11% and bamboo stem and leaf (BSL), with cellulose 21%, hemicelluloses 12% and lignin 12% [42].”
“The application of bamboo in many spheres of life as a suitable replacement for woody biomass in some instances provides arrays of opportunities in material industries. Bamboo being trees that grow and mature in a very short period of time can secure continuous supply of cheap tree and fibres compared to other woody biomasses. In addition, the excellent properties of bamboo enhanced via different chemical modification methods to improve their mechanical and thermal makes their fibre to be competitive with other materials used in the reinforcing of different polymers. With the application of correct treatment, suitable fibres can be extracted from bamboo for various purposes. And as such, several outstanding bamboo fibres can be obtained and incorporate other materials to produce excellent performance composites that can favourably compete with many conventional materials. [. . . ]”
“[. . . ] Although some of these applications are very limited in scope, continuous researches on bamboo can increase their potential and induce their aggressive interest in many more areas.”

As can be easily understood from the present patent specification and the accompanying drawings, the present footwear may come in the form of a footwear (and/or various other associated inventive aspects) including one and/or several of the following possible components and features (and/or different possible combination(s) and/or permutation(s) thereof):
1. A footwear for wearing on a foot of a user, the footwear comprising at least one component selected from the group consisting of an upper, a lining, a midsole, an outsole, an insole and at least one lace, wherein said at least one component is made of a material based on a lignocellulose substance (ex. a bamboo lyocell fabric, etc.).
2. A footwear according to any one of the preceding combination(s), wherein the footwear comprises a plurality of components (ex. a combination of components, etc.) selected from the group consisting of an upper, a lining, a midsole, an outsole, an insole and at least one lace.
3. A footwear according to any one of the preceding combination(s), wherein at least one of the upper and lining material is made of a material based on a lignocellulose substance.
4. A footwear according to any one of the preceding combination(s), wherein the material based on a lignocellulose substance for the upper and/or lining material is a lyocell based on a lignocellulose substance.
5. A footwear according to any one of the preceding combination(s), wherein the material based on a lignocellulose substance for the upper and/or lining material is made from a process having a step where lignocellulose plant (ex. bamboo, etc.) is transformed into lignocellulose chips (ex. wood chips, etc.).
6. A footwear according to any one of the preceding combination(s), wherein the material based on a lignocellulose substance for the upper and/or lining material is made from a process having a step where the lignocellulose chips are transformed into lignocellulose pulp (ex. wood pulp, etc.).
7. A footwear according to any one of the preceding combination(s), wherein the material based on a lignocellulose substance for the upper and/or lining material is made from a process having a step where the lignocellulose pulp is blended with water and at least one solvent so as to provide a cellulose fibre.
8. A footwear according to any one of the preceding combination(s), wherein the at least one solvent includes at least one organic solvent.
9. A footwear according to any one of the preceding combination(s), wherein the material based on a lignocellulose substance for the upper and/or lining material is made from a closed-loop process where water and/or solvent(s) are recycled.
10. A footwear according to any one of the preceding combination(s), wherein the material based on a lignocellulose substance for the upper and/or lining material is made from a process where the cellulose fiber is transformed (ex. spun, etc.) into yarn.
11. A footwear according to any one of the preceding combination(s), wherein the material based on a lignocellulose substance for the upper and/or lining material is made from a process where the yarn is transformed into a fabric.
12. A footwear according to any one of the preceding combination(s), wherein the material based on a lignocellulose substance for the upper and/or lining material is made from a process where the yarn is transformed into a lyocell.
13. A footwear according to any one of the preceding combination(s), wherein the material based on a lignocellulose substance for the upper and/or lining material is made from a process where the fabric (ex. lyocell, etc.) is died with a natural (ex. plant-based, etc.) dye (ex. Certified: OEKO TEX=100).
14. A footwear according to any one of the preceding combination(s), wherein the lignocellulose substance is bamboo, and thus, wherein the resulting fabric is a bamboo lyocell fabric.
15. A footwear according to any one of the preceding combination(s), wherein the bamboo lyocell fabric is a natural and non-blend bamboo lyocell fabric (ex. without polyethylene terephthalate (PET), etc.).
16. A footwear according to any one of the preceding combination(s), wherein both the upper and lining materials are made of the same fabric (ex. same bamboo lyocell fabric, having been dyed with natural, plant-based dye(s), for example).
17. A footwear according to any one of the preceding combination(s), wherein the upper (and/or upper material) of the footwear is made of a bamboo lyocell fabric having about 280 grams per square meter (gsm).
18. A footwear according to any one of the preceding combination(s), wherein the lining (and/or lining material) of the footwear is made of a bamboo lyocell fabric having about 135 grams per square meter (gsm).
19. A footwear according to any one of the preceding combination(s), wherein at least one of the midsole and outsole material is made of at least one material selected from the group consisting of perennial grass (ex. sugarcane, etc.—and more particularly, “sugarcane eva”, for instance) and resilient material (ex. “natural rubber”, etc.).
20. A footwear according to any one of the preceding combination(s), wherein the material for the midsole is made with a material based on a perennial grass (ex. “sugarcane eva”, etc.).
21. A footwear according to any one of the preceding combination(s), wherein the material for the midsole is made from a process having at least one of the following steps: a) transforming sugarcane into sugar extract; b) transforming sugar extract into ethanol; c) transforming ethanol (ex. via heating and/or melting) into pellets; d) transforming heated pellets into EVA (Ethylene-Vinyl Acetate) foam; e) transforming EVA foam into dyed and painted (ex. with natural and/or water-based paint(s) and/or dye(s), etc.); and/or f) any other additional step(s) being required.
22. A footwear according to any one of the preceding combination(s), wherein the material for the outsole is made from a process having at least one of the following steps: a) transforming natural rubber tree into latex sap being extracted; b) adding acid to latex in order to get latex jelly; c) flattening and/or rolling latex jelly into corresponding rubber sheet(s); d) allowing the rubber sheet(s) to dry (ex. via hanging thereof, etc.); e) painting the rubber sheet(s) (ex. with natural and/or water-based paint(s), etc.); and/or f) any other additional step(s) being required.
23. A footwear according to any one of the preceding combination(s), wherein the outsole includes a front outsole portion and a rear front outsole portion.
24. A footwear according to any one of the preceding combination(s), wherein the front outsole portion and the rear front outsole portion are separate portions (ex. separate pods).
25. A footwear according to any one of the preceding combination(s), wherein the outsole of the footwear is provided with at least one corresponding logo.
26. A footwear according to any one of the preceding combination(s), wherein the outsole of the footwear is provided with a logo of the LongRun™ shoe.
27. A footwear according to any one of the preceding combination(s), wherein the logo is provided between a front outsole portion and a rear front outsole portion of the footwear.
28. A footwear according to any one of the preceding combination(s), wherein at least one component of the footwear (ex. the insole material, foam collar, etc.) is provided with at least one Ortholite® product (ex. Ortholite® Impressions™, Ortholite® Foam (ex. Open Cell Foam), and/or any other product from Ortholite®).
29. A footwear according to any one of the preceding combination(s), wherein a plurality of components of the footwear (ex. the insole material, foam collar, etc.) are provided with at least one Ortholite® product (ex. Ortholite® Impressions™, Ortholite® Foam (ex. Open Cell Foam), and/or any other product from Ortholite®).
30. A footwear according to any one of the preceding combination(s), wherein at least the insole material of the footwear is provided with at least one Ortholite® product (ex. Ortholite® Impressions™, Ortholite® Foam (ex. Open Cell Foam), and/or any other product from Ortholite®).
31. A footwear according to any one of the preceding combination(s), wherein the insole material is made from a process having at least one of the following steps: a) transforming castor bean plant into cast bean oil being extracted; b) transforming recycled rubber into rubber specs; c) blending together into a particular Ortholite® foam; and/or d) any other additional step(s) being required.
32. A footwear according to any one of the preceding combination(s), wherein the insole of the footwear is provided with at least one corresponding logo.
33. A footwear according to any one of the preceding combination(s), wherein the insole of the footwear is provided with a logo of the LongRun™ shoe.
34. A footwear according to any one of the preceding combination(s), wherein the at least one lace is made of a polymeric material (ex. polyester, etc.).
35. A footwear according to any one of the preceding combination(s), wherein the at least one lace is made of a recycled polymeric material (ex. recycled plastic bottles, etc.).
36. A footwear according to any one of the preceding combination(s), wherein the at least one lace is made from a process having at least one of the following steps: a) transforming water bottles (ex. empty plastic water bottles) into recycled material; b) converting recycled single use plastic bottles into chipped flakes (ex. tiny flakes); c) transforming the flakes (ex. tiny flakes, via melting) into corresponding pellets (ex. tiny pellets); d) transforming pellets into yarn; e) dying the yarn (ex. with natural and/or water-based dye(s), etc.); f) transforming the yarn (ex. via spinning, etc.) into recycled polyester fabric; and/or g) any other additional step(s) being required
37. A footwear according to any one of the preceding combination(s), wherein the at least one lace includes a pair of laces, each lace being made of the same material.
38. A footwear according to any one of the preceding combination(s), wherein the at least one lace includes a pair of laces, each lace being made of a different material.
39. A footwear according to any one of the preceding combination(s), wherein the footwear is a water-resistant footwear.
40. A footwear according to any one of the preceding combination(s), wherein the footwear is a waterproof footwear.
41. A footwear according to any one of the preceding combination(s), wherein waterproofing of the footwear is provided by the nature and interconnection(s) of the components constituting the footwear.
42. A footwear according to any one of the preceding combination(s), wherein waterproofing of the footwear is provided by a corresponding coating and/or layering.
43. A footwear according to any one of the preceding combination(s), wherein waterproofing of the footwear is provided by a corresponding spray applied onto the footwear.
44. A footwear according to any one of the preceding combination(s), wherein the corresponding spray is made from a chemically-based compound and/or from a naturally-based compound.
45. A footwear according to any one of the preceding combination(s), wherein the footwear is selected from the group consisting of shoes, sneakers, boots, flip-flops, slippers, cleats, crocs, sandals, heels, and the like.
46. A footwear according to any one of the preceding combination(s), wherein shoes are selected from the group consisting of running shoes, dress shoes, casual shoes and the like.
47. A footwear according to any one of the preceding combination(s), wherein the footwear is commercialized under the trademark name of LongRun™, which is one possible trademark name contemplated by the Applicant/Assignee of the present case.
48. A kit with corresponding components for assembling a footwear according to any one of the preceding combination(s).
49. A method of manufacturing at least one component of a footwear according to any one of the preceding combination(s).

### Information about Possible “UPPER” and/or “LINING” Material(s) for the Present LongRun™ Shoe—(ex. “BAMBOO LYOCELL”):

Following is a brief description of a possible way of manufacturing an upper and/or lining material for the present footwear, using “bamboo lyocell”, for example, according to a possible embodiment of the present invention:

A) In regards to manufacturing steps:
Possible step(s) of Part No. 1:
a) Bamboo Plant 4 Wood Chips
b) Wood Chips 4 Wood pulp
c) Pulp blended with water & NMMO Solvent (organic) 4 Cellulose fibre (closed-loop process, water and solvent always recycled)
   (ex. a process similar to that described in U.S. pat. No. 8,926,712 B2, and/or other, for example, could be used for this latter step)
   Possible step(s) of Part No. 2:
a) Cellulose fibre 4 Spun into Yarn
   Possible step(s) of Part No. 3:
a) Yarn 4 Woven into Bamboo Lyocell fabric
   Possible step(s) of Part No. 4:
a) Bamboo Lyocell Fabric→Dyed with natural, plant-based dyes Certified: OEKO TEX—100

### B) Advantages:

Manufacturing an upper and/or lining material for the present footwear, using “bamboo lyocell”, for example, according to such a possible embodiment of the present invention, is advantageous in that, in the market, there are currently shoe uppers made from “Tencel”, this is “Lyocell” made with “eucalyptus trees”. However, and although the “Lyocell process” is an amazing, benign, eco-friendly process, extensive research and development carried out by the Applicant had determined that “Bamboo” has better benefits in terms of functionality and sustainability than “Eucalyptus” for a shoe upper. This is why the provision a “Bamboo Lyocell” for the upper of the shoe instead of “Tencel” is greatly advantageous.

C) Comparative Analysis between Bamboo and Tencel in terms of “functionality”:

| Factor(s) to be | With respect to | With respect to |
|---|---|---|
| considered: | “Bamboo”: | “Eucalyptus (Tencel)”: |
| Soft and Silky | Yes | — |
| Hypoallergenic | Yes | — |
| Breathable | Yes | — |
| Thermo-regulating | Yes | — |
| Naturally-antibacterial | Yes | — |
| Absorbent and Moisture- | Yes | Yes but less |
| wicking | | |
| UV Protective | Yes | No |
| Biodegradable | Yes | — |
| Durable | Yes | — |

As may now be better appreciated, in terms of “functionality”: bamboo offers more technical features than eucalyptus which enhances the comfort of the present shoe (one of the main selling points for the commercialization of the product), those being: it's hypoallergenic, thermos-regulating, naturally-antibacterial, more absorbent and moisture-wicking and UV protective.

D) Comparative analysis between Bamboo and Tencel in terms of “sustainability”:

| Factor(s) to be | With respect to | With respect to |
|---|---|---|
| considered: | “Bamboo”: | “Eucalyptus (Tencel)”: |
| Tree Growth | Grows 3 ft per day | Grows 6-12 ft per year |
| (Renewability) | | |
| Oxygen Release | 35% more than most | 35% less than Bamboo |
| | trees | |
| Pesticides | No | No |
| Herbicides | No | No |
| Fertilizers | No | No |
| Irrigation | No, rainwater | No, rainwater |
| Closed Loop | Yes | Yes |
| Tree | Does not need to be | Cut down to harvest the |
| | completely cut down | wood |

As may now be better appreciated, in terms of “sustainability”: bamboo is better for the planet and more sustainable than eucalyptus which enhances the eco-friendly percentage of the present shoe (again, one of the main selling points for the commercialization of the product) because: bamboo grows so much faster meaning it is a more renewable resource causing basically no deforestation, it does not need to be completely cut down to harvest whereas the eucalyptus trees do, and it emits 35% more oxygen than all other trees, meaning it absorbs more toxic greenhouse gases, etc.

### Information about Possible “MIDSOLE” and/or “OUTSOLE” Material(s) for the Present LongRun™ Shoe—(ex. “SUGARCANE EVA” and/or “NATURAL RUBBER”)

Following is a brief description of a possible way of manufacturing a midsole and/or outsole material for the present footwear, using “sugarcane eva” and/or “natural rubber”, for example, according to a possible embodiment of the present invention:

A) In regards to manufacturing steps (“Midsole”):
Possible step(s) of Part No. 1:
a) Sugarcane→Sugar Extract
b) Sugar Extract→Ethanol
c) Ethanol heated and melted→Pellets
d) Pellets→Heated into melted foam
   Possible step(s) of Part No. 2:
a) Melted Foam→EVA Foam
   Possible step(s) of Part No. 3:
a) EVA Foam→Dyed and Painted with Natural/water-based paint and dyes.
   A) In regards to manufacturing steps (“Outsole”):
   Possible step(s) of Part No. 1:
a) Natural Rubber tree→Latex sap extracted
b) Acid added to Latex→Latex Jelly
   Possible step(s) of Part No. 2:
a) Latex Jelly flattened and rolled into rubber sheets
b) Rubber sheets hung to dry
   Possible step(s) of Part No. 3:
a) Rubber sheets→Painted with Natural/water-based paint

### B) Advantages:

Manufacturing a midsole and/or outsole material for the present footwear, using “sugarcane eva” and/or “natural rubber”, for example, according to such a possible embodiment of the present invention, is advantageous in that, “Sugarcane EVA” is advantageous as a midsole because of its amazing functional and sustainable properties (see below) - however, Applicant has realized that “Sugarcane” only as much as it is soft, bouncy and extremely comfortable, it is not abrasion resistant and durable enough to last if it is going to be touching the ground. Therefore, the Applicant has decided on “Natural Rubber” outsole pods which are strong and tear and abrasion resistant to be the part of the shoe touching the ground for the ultimate mix of “comfort” and “durability”.

C) Overview of Sugarcane and Natural Rubber in terms of “functionality”:

| Factor(s) to be | With respect to | With respect to |
|---|---|---|
| considered: | “Sugarcane”: | “Natural Rubber”: |
| Bio % content | 0-100% (and preferably, | 30% |
| | about 40-50% *TBD) | |
| Bouncy | Yes | Not really |
| Comfortable | Yes | Not really |
| Soft | Yes | Not really |
| High Rebound | Yes | Not really |
| Lightweight | Yes | Not really |
| Biodegradable | Yes | Yes |
| Resilient | Somewhat | High resilience |
| Tear (Abrasion) | Not really | Yes |
| Resistance | | |
| Slip Resistance | Not really | Yes |
| Waterproof | Not really | Yes |
| Multi-weather strength | Not really | Yes |

As may now be better appreciated, in terms of “functionality”: the mix of a “Sugarcane EVA” midsole with a “Natural Rubber” outsole is the perfect balance between “durability” and “comfortability”. The midsole offers undeniable comfort properties with its bouncy, high rebound and soft properties whereas the outsole offers strong and reliable support which is resistant and resilient.

D) Overview of Sugarcane and Natural Rubber in terms of “sustainability”:

| Factor(s) to be | With respect to |
|---|---|
| considered: | “Sugarcane”: |
| Tree Growth (Renewability) | Grows very quickly when cut |
| Oxygen Release | 35% more than most trees |
| Pesticides | No |
| Herbicides | No |
| Fertilizers | Uses its own biomass |
| Irrigation | No, rainwater |
| Self-sufficient | Yes |
| Tree | Does not need to be completely cut down |

As may now be better appreciated, in terms of “sustainability”: Sugarcane is great for the planet and more sustainable than other options in the market, which enhances the eco-friendly percentage of the present shoe (again, one of the main selling points for the commercialization of the product) because sugarcane grows so fast, meaning it is a more renewable resource causing basically no deforestation, it does not need to be completely cut down to harvest and it is so self-sufficient, its biomass can be extracted to power the mill and fertilize the next year's crops, etc.

| Factor(s) to be | With respect to |
|---|---|
| considered: | “Natural Rubber”: |
| Harvesting/Tapping | Safe harvesting of natural latex |
| | through ethical tapping |
| Oxygen Release | Trees are not cut down so |
| | constant Oxygen release |
| Pesticides | No |
| Herbicides | No |
| Fertilizers | No |
| Irrigation | No |
| Tree | Unharmed - do not need to be cut down |

As may now be better appreciated, in terms of “sustainability”: Natural Rubber is a great alternative to regular rubber because instead of cutting down the tree, the tree is ethically tapped to extract the natural latex leaving the tree unharmed and able to continue their job of absorbing toxic greenhouse gases and releasing oxygen into the air, etc.

### Information about Possible “INSOLE” Material(s) for the Present LongRun™ Shoe—(ex. “ORTHOLITE IMPRESSIONS”)

Following is a brief description of a possible way of manufacturing an insole material for the present footwear, using “ortholite impressions”, for example, according to a possible embodiment of the present invention:

A) In regards to manufacturing steps:
Possible step(s) of Part No. 1:
a) Castor Bean Plant→Castor bean oil extracted
b) Recycled Rubber→Rubber specs
   Possible step(s) of Part No. 2:
a) Blended together into proprietary Ortholite Foam

### B) Advantages:

Manufacturing an insole material for the present footwear, using “ortholite impressions”, for example, according to such a possible embodiment of the present invention, is advantageous in that, “Ortholite Impressions” are Ortholite's most comfortable insoles with the highest Bio content containing about 50% Castor Bean Oil and about 5% Recycled Rubber—thus, ensuring ultimate comfort as well as an eco-friendly solution to unsustainable insoles that are already on the market.

C) Overview of Ortholite Impressions in terms of “functionality”:

| Factor(s) to be | With respect to |
|---|---|
| considered: | “Ortholite Impressions”: |
| Long-term cushioning | Yes |
| Moisture-management | Yes |
| Breathable | Yes |
| Lightweight | Yes |
| Easy Wash | Yes |
| Anti-microbial | Yes |
| Custom fit feel | Yes |

D) Overview of Ortholite Impressions in terms of “sustainability”:

| Factor(s) to be | With respect to |
|---|---|
| considered: | “Ortholite Impressions”: |
| Bio % | 55% |
| Production | Ortholite low-waste proprietary technology |
| Tree | Desert plant = no competing with other food |
| | sources |
| Irrigation | No, rainwater |
| Growth (Renewability) | Very fast - 10 ft/season |

### Information about Possible “LACE(S)” Material(s) for the Present LongRun™ Shoe—(ex. “RECYCLED PLASTIC BOTTLES”)

Following is a brief description of a possible way of manufacturing lace(s) material for the present footwear, using “recycled plastic bottles”, for example, according to a possible embodiment of the present invention:

A) In regards to manufacturing steps:
Possible step(s) of Part No. 1:
a) Water Bottles→Recycled
b) Recycled single use plastic bottles→chipped into tiny flakes
c) Tiny flakes→Melted into tiny pellets
   Possible step(s) of Part No. 2:
a) Pellets drawn into Yarn
   Possible step(s) of Part No. 3:
a) Yarn Dyed with natural dyes
   Possible step(s) of Part No. 4:
a) Yarn spun into Recycled Polyester fabric

### B) Advantages:

Manufacturing lace(s) material for the present footwear, using “recycled plastic bottles”, for example, according to such a possible embodiment of the present invention, is advantageous in that, in the market, there are tons of different types of laces, “Polyester” is one of the most highly used materials. By creating “Recycled Polyester” laces, we are able thanks to the present invention to remove tons of “plastic bottles” from landfills and from oceans to repurpose them into the shoelace material for the present shoe, etc.

C) Overview of Recycled Polyester in terms of “functionality”:

| Factor(s) to be | With respect to |
|---|---|
| considered: | “Recycled Polyester”: |
| High Tensile Strength | Yes |
| Washable | Yes |
| Wrinkle-resistant | Yes |
| Moisture-wicking | Yes |
| Shrink and stretch resistant | Yes |
| Abrasion resistant | Yes |

D) Overview of Recycled Polyester in terms of “sustainability”:

| Factor(s) to be | With respect to |
|---|---|
| considered: | “Recycled Polyester”: |
| Bio % | 100% |
| Plastic | Removes plastic from oceans and landfills |
| Contamination | Reduces soil, air and water contamination |
| Energy | Requires 59% less energy than virgin |
| | polyester |
| Greenhouse gases | Way less than virgin polyester |
| Closed Loop | Recycled again and again without quality |
| | degradation |

As can be easily understood, in addition to the various innovative components and features of the present system, and explained and/or exemplified in the present patent specification, the footwear according to the present invention could also be provided with various other known components and features of other conventional footwear and the like being well known (ex. reflective portion(s), step counter(s), electronic chip(s), shock-absorber(s), etc.), as apparent to a person skilled in the art.

As may now be better appreciated, the present footwear is a considerable improvement over conventional systems in that it overcomes the many drawbacks and inconveniences associated with conventional footwear, in that it comprises at least one component, and optionally, a combination of components, made of a material based on a lignocellulose substance, and having been converted into a corresponding fabric (ex. a bamboo lyocell fabric, etc.), without, or at the very least, with considerably reduced chemicals or synthetics like rayon (polyester), etc. Moreover, and as aforementioned, according to a preferred embodiment of the present system, the bamboo lyocell fabric used for the footwear and component(s) thereof is all “natural” and “non-blend” (ex. without polyethylene terephthalate (PET), etc.). Therefore, and as may now be better appreciated, the resulting present footwear according to the present system provides various advantages in terms of “sustainability” and “functionality”, when compared to conventional footwear.

Furthermore, the present footwear is advantageous in that it offers an innovative design with minimal components that can be modular and/or interchangeable depending on the applications(s) for which the footwear is intended for, and the desired end result(s), and the present footwear is also advantageous in that it enables to provide a great variety of different types of configuration(s) and/or application(s) with a same footwear design and corresponding manufacturing process(es), in a quicker, simpler, more precise, more efficient, more economical, more reliable, more adjustable, more versatile, more adaptable, more durable, more environmentally conscientious, more functional, more sustainable, more desirable, and/or improved manner, than what is possible with the actual way of doing things.

Finally, and according to the present invention, the present footwear and its corresponding parts are preferably made of substantially rigid materials, such as hardened polymers, composite materials, and/or any other appropriate material, for certain parts of the footwear, whereas the other components of the system according to the present invention, in order to obtain the advantages discussed above, could be made of any other appropriate material, such as polymeric materials (ex. plastic, rubber, etc.), and/or any other suitable material, depending on the particular applications for which the system is intended for and the different parameters in cause (ex. loads being involved, overall weight of the shoe being desired, flexibility of the shoe being required, etc.), as apparent to a person skilled in the art.

Although the present invention has been previously explained by way of preferred embodiments, it is to be understood that any modification to these preferred embodiments is not considered changing nor altering the nature and the scope of the present invention. Indeed, and as can be easily understood by a person skilled in the art, the scope of the claims should not be limited by the possible embodiments set forth in the examples, but should be given the broadest interpretation consistent with the description as a whole.

Furthermore, although preferred embodiments of the present invention have been briefly described herein and illustrated in the accompanying drawings, it is to be understood that the invention is not limited to these embodiments and that various changes and modifications could be made without departing form the scope and spirit of the present invention, as defined in the appended claims and as apparent to a person skilled in the art.

1. A footwear for wearing on a foot of a user, the footwear comprising at least one component selected from the group consisting of an upper, a lining, a midsole, an outsole, an insole and at least one lace, wherein said at least one component is made of a material based on a lignocellulose substance.

2. A footwear according to claim 1, wherein the footwear comprises a plurality of components selected from said group.

3. A footwear according to claim 1, wherein at least one of the upper and the lining of the footwear is made of a material based on a lignocellulose substance.

4. A footwear according to claim 3, wherein the material used for the upper and/or the lining of the footwear is a lyocell based on a lignocellulose substance.

5. A footwear according to claim 3, wherein the material used for the upper and/or the lining of the footwear is made from a process having a step wherein a lignocellulose plant is transformed into lignocellulose chips.

6. A footwear according to claim 5, wherein the material used for the upper and/or the lining of the footwear is made from a process having a step where the lignocellulose chips are transformed into lignocellulose pulp.

7. A footwear according to claim 6, wherein the material used for the upper and/or lining of the footwear is made from a process having a step where the lignocellulose pulp is blended with water and at least one solvent so as to provide a cellulose fibre;
wherein the at least one solvent includes at least one organic solvent;
wherein the material used for the upper and/or lining of the footwear is made from a closed-loop process wherein water and said at least one solvent are recycled; and
wherein the cellulose fibre is transformed into either a yarn, a fabric or a lyocell fabric, the lyocell fabric being died with a natural plant-based dye.

8-13. (canceled)

14. A footwear according to claim 1, wherein the lignocellulose substance is bamboo, and wherein a resulting portion of the footwear is made with a bamboo lyocell fabric;
wherein the bamboo lyocell fabric is a natural and non-blend bamboo lyocell fabric deprived of any polyethylene terephthalate (PET); and
wherein both the upper and the lining of the footwear are made with said bamboo lyocell fabric.

15-16. (canceled)

17. A footwear according to claim 1, wherein the upper of the footwear has a density of about 280 grams per square meter (gsm); and wherein the lining of the footwear has a density of about 135 grams per square meter (gsm).

18. (canceled)

19. A footwear according to claim 1, wherein at least one of the midsole and the outsole of the footwear is made of at least one material selected from the group consisting of perennial grass and resilient material.

20. A footwear according to claim 1, wherein a material used for the midsole of the footwear is made with sugarcane ethylene-vinyl acetate (EVA).

21. A footwear according to claim 20, wherein the material used for the midsole of the footwear is made from a process having at least one of the following steps: a) transforming sugarcane into sugar extract; b) transforming sugar extract into ethanol; c) transforming ethanol into pellets; d) transforming pellets into EVA (Ethylene-Vinyl Acetate) foam; and e) transforming EVA foam into a dyed and painted midsole.

22. A footwear according to claim 1, wherein a material used for the outsole of the footwear is made from a process having at least one of the following steps: a) transforming natural rubber tree into latex sap being extracted; b) adding acid to latex in order to get latex jelly; c) flattening latex jelly into at least one corresponding rubber sheet; d) allowing said at least one corresponding rubber sheet to dry; and e) painting said at least one corresponding rubber sheet with natural and water-based paint.

23. A footwear according to claim 1, wherein the outsole of the footwear includes a front outsole portion and a rear front outsole portion;
wherein the front outsole portion and the rear front outsole portion of the footwear are separate portions;
wherein the outsole of the footwear is provided with at least one corresponding logo;
wherein said at least one corresponding logo of the outsole of the footwear includes a LongRun™ logo; and
wherein a logo is provided between the front outsole portion and the rear outsole portion of the footwear.

24-27. (canceled)

28. A footwear according to claim 1, wherein at least one component of the footwear is provided with at least one Ortholite® product.

29. A footwear according to claim 1, wherein a plurality of components of the footwear are provided with at least one Ortholite® product; and wherein at least the insole of the footwear is made with a material provided with said at least one Ortholite® product.

30. (canceled)

31. A footwear according to claim 1, wherein a material used for the insole of the footwear is made from a process having at least one of the following steps: a) transforming castor bean plant into castor bean oil being extracted; b) transforming recycled rubber into rubber specs; and c) blending together into a particular Ortholite® foam.

32-33. (canceled)

34. A footwear according to claim 1, wherein the at least one lace is made of a polymeric material;
wherein the at least one lace is made of a recycled polymeric material;
wherein the at least one lace is made from a process having at least one of the following steps: a) transforming empty plastic water bottles into recycled material; b) converting said recycled material into chipped flakes; c) transforming the flakes into corresponding pellets; d) transforming pellets into yarn; e) dying the yarn; and f) transforming the yarn into recycled polyester fabric; and
wherein the at least one lace includes a pair of laces, each lace being made of a same material, or each lace being made of a different material.

35-38. (canceled)

39. A footwear according to claim 1, wherein the footwear is either a water-resistant footwear or a waterproof footwear, the waterproofing of the footwear being provided by the nature and interconnections of components comprising the footwear, by a corresponding coating and/or by a corresponding spray applied onto the footwear, the corresponding spray being made from a compound selected from the group consisting of a chemically-based compound and a naturally-based compound.

40-44. (canceled)

45. A footwear according to claim 1, wherein the footwear is selected from the group consisting of shoes, sneakers, boots, flip-flops, slippers, cleats, crocs, sandals and heels; and wherein the shoes are selected from the group consisting of running shoes, dress shoes and casual shoes.

46-48. (canceled)
